(19) United States
(12) Patent Application Publication
(10) Pub. No.: US 2010/0084388 A1
(43) Pub. Date: Apr. 8, 2010

(54) WELDING ELECTRODE AND METHOD OF MANUFACTURE

(75) Inventors: Gregory A. GERTH, Kirtland, OH (US); Patrick T. SOLTIS, Shaker Heights, OH (US); Lisa S. MCFADDEN, Elyria, OH (US)

Correspondence Address: HAHN LOESER / LINCOLN, ONE GOJO PLAZA, SUITE 300, AKRON, OH, 44311-1076, US

(73) Assignee: LINCOLN GLOBAL, INC., City of Industry, CA (US)

(21) Appl. No.: 12/246,050

(22) Filed: Oct. 6, 2008

(51) Int. Cl. B23K 35/04; B23K 35/40

(52) U.S. Cl. 219/145.22; 29/746

(57) ABSTRACT

A welding electrode includes a sheath formed from a strip of metal having first and second edges. The sheath has an initial cross-sectional area and a second as-drawn cross-sectional area, and a core is received within the sheath. The second cross-sectional area is at least an 80% reduction of the initial cross-sectional area.

### TECHNICAL FIELD

The invention pertains to welding electrodes, and more particularly to flux-cored electrodes.

### BACKGROUND OF THE INVENTION

Flux-cored electrodes may be manufactured using a process that employs feeder rod, known as “green rod.” In one process, the green rod is formed into a u-shaped channel, filled with the desired welding flux, mechanically deformed to create a sheath surrounding the flux, and then drawn through a series of dies to the desired final electrode diameter. In another process, the “green rod” may be replaced by steel strip which forms approximately the same depth u-shaped channel prior to filling. Among the difficulties that result from manufacturing flux-cored electrodes in this manner is that portions of the powdered flux spill from the relatively shallow channel during filling and subsequent forming operations.

Another known difficulty that results from manufacturing electrodes in this manner is that the sheath may break in the reducing dies if drawn to too great of a reduction in cross-sectional area. Typically, the amount of reduction in cross-sectional area is calculated to correspond to a predetermined sheath diameter. It is known in the art that reducing the cross-sectional area of the sheath by greater than approximately 60% results in such breakage. Once the sheath is broken in the drawing die, it becomes necessary to weld the sheath back together so that drawing process may continue. Usually, the process continues for a short period until the sheath breaks again at another location. The unpredictable, yet frequent, nature of this breakage has until now resulted in those in the art not attempting to reduce the cross-sectional area of sheaths by greater than 60% using a drawing process. It is believed that increasing the initial cross-sectional area of the sheath and drawing to a pre-determined hardness using drawing equipment having the requisite horsepower may alleviate such breakage problems.

In another aspect of flux-cored electrodes, it is known that the tip of the electrode must be sufficiently clean for a welding arc to be struck between the workpiece and the electrode. As a result of prior welding activity, the tip of the electrode may be covered with slag or other contamination. Thus, the tip must be cut or broken off by the welder prior to striking an arc. Traditional flux-cored electrodes are too soft to be broken or snapped off by hand; the electrode merely deforms without breaking when bent by a welder. Therefore, welders carry and use wire cutters to create a “clean” tip. Periodically, a welder may stop welding to inspect the quality of the weld or simply because of muscle fatigue. After each stoppage, a welder must then pull out wire cutters to produce the necessary “clean” tip before welding can be commenced, thereby adding additional steps to the welding process and decreasing the efficiency of the welder.

### BRIEF SUMMARY

In one embodiment a welding electrode includes a sheath formed from a strip of metal having first and second edges. The sheath has an initial cross-sectional area and a second as-drawn cross-sectional area, and a core is received within the sheath. The second cross-sectional area is at least an 80% reduction of the initial cross-sectional area.

### BRIEF DESCRIPTION OF THE DRAWINGS

FIG. 1 is a cross sectional view of a welding electrode, according to one of the embodiments of the subject invention.

FIG. 2 is a cross sectional view of a welding electrode, according to one of the embodiments of the subject invention.

FIG. 3 is a block diagram of a method of manufacturing a welding electrode, according to one of the embodiments of the subject invention.

FIG. 4 is a block diagram of a method of manufacturing a welding electrode, according to another one of the embodiments of the subject invention.

### DETAILED DESCRIPTION OF THE INVENTION

Referring now to the drawings wherein the showings are for purposes of illustrating embodiments of the invention only and not for purposes of limiting the same, FIG. 1 shows the cross section of a welding electrode 10 constructed in accordance with one embodiment of the subject invention. The welding electrode 10 may comprise a sheath 20 formed from a strip of metal which may have a first edge 22 and a second edge 24. The welding electrode may further comprise a core composition 30, which may be received within the sheath 20.

In one embodiment, the first and second edges 22, 24 may be substantially parallel. In another embodiment, the metal strip may have an initial thickness of 0.04 inches and an initial width of 1.05 inches. In still another embodiment, the metal strip may comprise steel, aluminum, or any other metal or metal alloy with suitable mechanical properties such that the metal may be formed into a sheath. As the sheath 20 is formed from the metal strip, the metal strip may first be formed into a channel by applying forces using forming equipment known in the art.

Once the metal strip has been formed into a channel, the core composition 30 may be deposited into the channel. As the core composition 30 may be a powdered material, the core composition 30 may be fed by a powder feeder, as known in the art, into the channel. In one embodiment, the core composition 30 may include at least one gas generating compound, whereby the generated gas may shield the weld pool from the ambient environment during the welding operation. In another embodiment, the core composition 30 may include at least one alloying metal which may be used to facilitate forming a weld metal with a desired composition. It is also contemplated that the core composition 30 may include a composition including at least one of at least one gas generating compound and at least one alloying agent.

Once the core composition 30 has been deposited into the channel, the sheath 20 may be formed by applying forces to the both the first edge 22 and the second edge 24 of the metal strip, thereby enclosing the core composition 30 within the sheath 20. In one embodiment, the first edge 22 and second edge 24 may be formed such that the first edge 22 overlaps the second edge 24, forming what may be known as a “lap seam.”

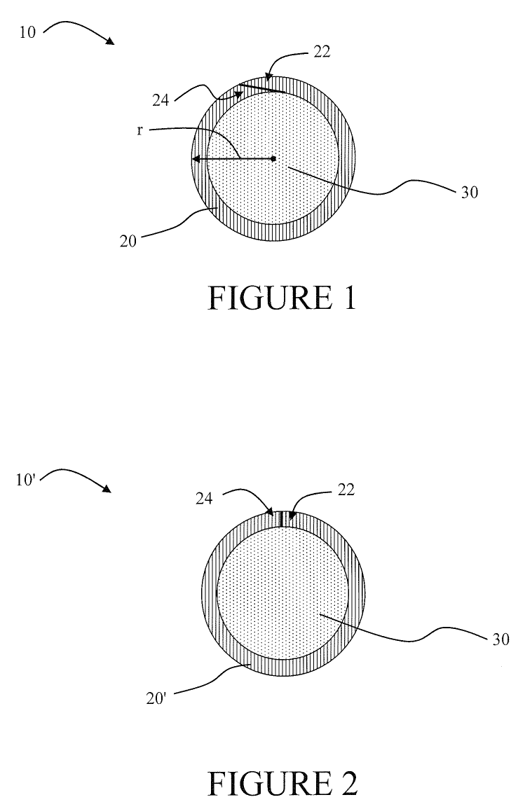

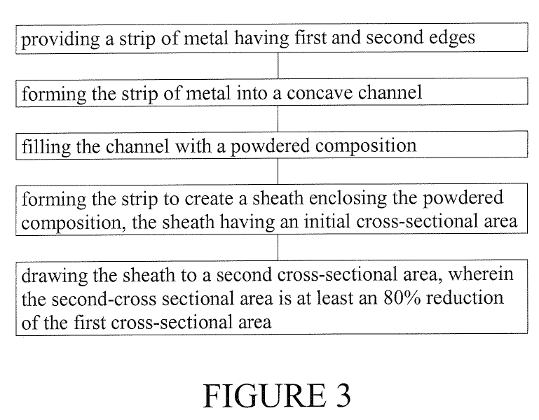

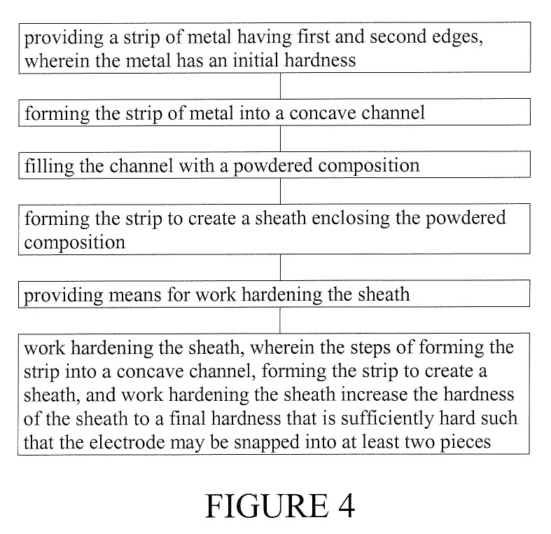

In another embodiment shown in FIG. 2, a welding electrode 10′ may include a sheath 20′ having a “butt seam.” By a “butt seam” is meant a seam where the end of the first edge 22 abuts, rather than overlaps, the second edge 24.

Referring again to FIG. 1, once the sheath 20 has been formed and the core 30 is received within the sheath 20, the sheath 20 and core 30 may be generally round in cross-section and may have a radius r. The initial cross-sectional area of the sheath 20 may be calculated using the formula πr². Once the sheath 20 has been formed, it may be passed through a reducing die or series of reducing dies, in a process known generally as drawing. As a result of the drawing process, the radius r may be decreased, the length of the sheath 20 may be elongated, and the core composition 30 may be compacted. In one embodiment, the radius of the sheath 20 may be decreased to a value such that the cross-sectional area of the sheath 20 after the drawing process, known as the “as-drawn” cross-sectional area, may be at least an 80% reduction of the initial cross-sectional area. For example, the decreased radius of the sheath may be between 0.0360 inches and 0.0465 inches. In a further embodiment, the reduction in cross-sectional area from the initial area to the as-drawn area may be approximately 90%. In still a further embodiment, the reduction in cross-sectional area from the initial area to the as-drawn area may be approximately 97%.

As the sheath 20 is subjected to the drawing process, the hardness of the sheath may increase due to a phenomenon known as work hardening. Work hardening is the phenomenon whereby a ductile metal becomes harder and stronger as it is plastically deformed due to an increase in the dislocation density of the metal. In one embodiment, the hardness of the sheath 20 may be increased to a hardness that is sufficient such that the electrode 10 may be snapped into two pieces. For example, the tip of the electrode may be grasped between a welder's fingers, by pliers, or by some other grasping implement and subjected to a sudden increase in force, whereby the electrode 10 may be snapped into at least two pieces. In another embodiment, the hardness of the sheath 20 may be at least 200 Vickers 500 g microhardness, as measured by a standard Vickers microhardness testing device with a 500 g load.

In a further embodiment of the subject invention, a welding electrode 10 may be manufactured from a metal strip having an initial hardness and including first and second edges 22, 24. The strip of metal may be formed into a concave channel, and the channel may be filled with a powdered composition 30. Subsequently, the channel may be formed to create a sheath 20 enclosing the powdered composition 30. Means for work hardening the sheath 20 may then be provided. Such means for work hardening may include a forming die, a reducing die or series of said dies in combination. The means for work hardening the sheath may then be employed to work harden the sheath 20. The processes of forming the strip into a concave channel, further forming the strip to create a sheath, and work hardening the sheath may increase the hardness of the sheath to a final hardness such that the sheath may be snapped into at least two pieces.

The invention has been described herein with reference to the disclosed embodiments. Obviously, modifications and alterations will occur to others upon a reading and understanding of this specification. It is intended to include all such modifications and alterations insofar as they come within the scope of the appended claims or the equivalence thereof.

What is claimed is:

1. A welding electrode comprising:
a sheath formed from a strip of metal having first and second edges, the sheath having an initial cross-sectional area and a second as-drawn cross-sectional area; and
a core received within the sheath,
wherein the second cross-sectional area is at least an 80% reduction of the initial cross-sectional area.

2. The electrode of claim 1, wherein the at least 80% reduction is approximately 90%.

3. The electrode of claim 1, wherein the at least 80% reduction is approximately 97%.

4. The electrode of claim 1, wherein the first and second edges are substantially parallel.

5. The electrode of claim 4, wherein the strip of metal has an initial thickness of approximately 0.04 inches and an initial width of approximately 1.05 inches.

6. The electrode of claim 4, wherein the first edge overlaps the second edge.

7. The flux-cored electrode of claim 1, wherein the sheath has sufficient hardness such that the electrode may be snapped into at least two pieces.

8. The electrode of claim 7, the hardness being at least 200 Vickers 500 g microhardness.

9. The electrode of claim 1, wherein the core includes at least one gas-generating compound.

10. The electrode of claim 1, the core including at least one metal alloying agent.

11. A method for manufacturing a welding electrode comprising the steps of:
providing a strip of metal having first and second edges;
forming the strip of metal into a concave channel;
filling the channel with a powdered composition;
further forming the strip to create a sheath enclosing the powdered composition, the sheath having an initial cross-sectional area; and
drawing the sheath to a second cross-sectional area, wherein the second-cross sectional area is at least an 80% reduction of the first cross-sectional area.

12. The method of claim 11, wherein the at least 80% reduction is approximately 90%.

13. The method of claim 11, wherein the at least 80% reduction is approximately 97%.

14. The method of claim 11, wherein the first and second edges are substantially parallel.

15. The method of claim 14, wherein the strip of metal has an initial thickness of approximately 0.04 inches and an initial width of approximately 1.05 inches.

16. The electrode of claim 14, wherein the first edge overlaps the second edge.

17. The method of claim 11, wherein the sheath has sufficient hardness such that the electrode may be snapped into at least two pieces.

18. The method of claim 17, the hardness being at least 200 Vickers 500 g microhardness.

19. The method of claim 11, wherein the core includes at least one of a gas-generating compound and a metal alloying agent.

20. A method for manufacturing a welding electrode comprising the steps of:
providing a strip of metal having first and second, wherein the metal has an initial hardness;
forming the strip of metal into a concave channel;
filling the channel with a powdered composition;
further forming the strip to create a sheath enclosing the powdered composition;
providing means for work hardening the sheath; and
work hardening the sheath,
wherein the steps of forming the strip into a concave channel, forming the strip to create a sheath, and work hardening the sheath increase the hardness of sheath to a final hardness that is sufficiently hard such that the electrode may be snapped into at least two pieces.
